(19) United States
(12) Patent Application Publication
(10) Pub. No.: US 2023/0415755 A1
(43) Pub. Date: Dec. 28, 2023

(54) COMPUTER-IMPLEMENTED METHOD AND SYSTEM FOR CREATING A VIRTUAL ENVIRONMENT FOR A VEHICLE

(71) Applicant: dSPACE GmbH, Paderborn (DE)

(72) Inventors: Leon BOHNMANN, Aachen (DE); Frederik VIEZENS, Paderborn (DE)

(73) Assignee: dSPACE GmbH, Paderborn (DE)

(21) Appl. No.: 18/212,479

(22) Filed: Jun. 21, 2023

(30) Foreign Application Priority Data
Jun. 23, 2022 (EP) 22180630.0

(51) Int. Cl. B60W 50/02; B60W 60/00

(52) U.S. Cl. CPC B60W 50/0205; B60W 60/001; B60W 2420/52; B60W 2554/4029; B60W 2552/53; B60W 2555/60; B60W 2554/404; B60W 2554/20

(57) ABSTRACT

A computer-implemented method and system for generating a virtual environment for a vehicle for testing highly automated driving functions of a motor vehicle. The method comprises projecting the pixel-based classified camera image data onto the pre-acquired LiDAR point cloud data, wherein each point of the LiDAR point cloud, superimposed by classified pixels of the camera image data, in particular having the same image coordinates, is assigned an identical class and an instance segmentation of the classified LiDAR point cloud data for determining at least one real object comprised by a class. A computer program and a computer-readable data carrier are also provided.

This nonprovisional application claims priority under 35 U.S.C. § 119(a) to European Patent Application No. 22180630.0, which was filed in Europe on Jun. 23, 2022, and which is herein incorporated by reference.

### BACKGROUND OF THE INVENTION

### Field of the Invention

The present invention relates to a computer-implemented method for generating a virtual vehicle environment for testing highly automated driving functions of a motor vehicle. The invention further relates to a system for generating a virtual vehicle environment for testing highly automated driving functions of a motor vehicle.

### Description of the Background Art

Graphical user interfaces for testing highly automated driving functions of a motor vehicle usually have a plurality of components that enable the management of parameter sets, the creation of a virtual vehicle environment and experiment management.

Scene building of the virtual vehicle environment, i.e., the definition of static and dynamic objects of a scene, is carried out by manual configuration and import of objects stored in an object library.

CN 000205121971 U discloses a method for testing autonomous vehicles. According to the method, an autonomous vehicle is generated in a simulation environment. According to pre-recorded status information of a virtual vehicle, a traffic environment is set up in the simulation environment to enable the autonomous vehicle to drive in the traffic environment.

However, the above-mentioned methods have in common that there is a high effort to create the virtual vehicle environment for testing the highly automated driving functions of the motor vehicle, which results in high levels of personnel and high cost.

Consequently, there is a need to improve existing methods and systems for creating a virtual vehicle environment for testing highly automated driving functions of a motor vehicle in such a way as to enable simplified, efficient and cost-effective creation of the virtual vehicle environment.

### SUMMARY OF THE INVENTION

It is therefore the object of the invention to provide a computer-implemented method, a system, a computer program and a computer-readable data carrier, which enable a simplified, more efficient and cost-effective generation of a virtual vehicle environment for testing highly automated driving functions of a motor vehicle.

The object is achieved according to the invention by a computer-implemented method for generating a virtual vehicle environment for testing highly automated driving functions of a motor vehicle.

The method includes the provision of pre-acquired camera image data and LiDAR point cloud data of a real vehicle environment as well as a pixel-based classification of the pre-acquired camera image data using a machine learning algorithm that provides an associated class for each pixel and outputs a confidence value corresponding to the classification.

Furthermore, the method comprises projecting the pixel-based, classified camera image data onto the pre-acquired LiDAR point cloud data, wherein each of the points of the LiDAR point cloud, superimposed by classified pixels of the camera image data and in particular having the same image coordinates, are assigned an identical class.

Projecting the pixel-based, classified camera image data onto the pre-acquired LiDAR point cloud data advantageously enables that the three-dimensional representation of the point cloud can be enriched by further information such as a class and/or a color value.

The method further comprises an instance segmentation of the classified LiDAR point cloud data for determining at least one real object comprised by a class and a selection and call of a stored, synthetically generated first object corresponding to the at least one real object, or procedural generation of a synthetically generated second object corresponding to the at least one real object.

In addition, the method includes integrating the synthetically generated first object or the synthetically generated second object into a specified virtual vehicle environment.

The real vehicle environment corresponds to a vehicle environment of the motor vehicle in road traffic, in particular in a plurality of road traffic situations. The real objects can be static objects such as traffic signs, buildings, landscaping and/or parked motor vehicles. Furthermore, the real objects can be dynamic objects such as moving motor vehicles.

The synthetically generated objects are divided into different object categories and represent the real objects contained in the camera image data and/or the LiDAR point cloud of the real vehicle environment.

The virtual vehicle environment may be a computer-generated representation of the sensor-based, recorded real vehicle environment.

Procedural generation refers to a method of generating 3-D objects in real time during the execution of the computer program. The 3-D objects are not generated randomly, but the generation follows deterministic algorithms in order to be able to generate the same content again and again under the same initial conditions.

The invention further relates to a system for generating a virtual vehicle environment for testing highly automated driving functions of a motor vehicle.

The system comprises a data store for providing pre-acquired camera image data and LiDAR point cloud data of a real vehicle environment as well as a calculation device for pixel-based classification of the pre-acquired camera image data using a machine learning algorithm, which is set up for outputting for each pixel an associated class and a confidence value corresponding to the classification. The calculation device can be, for example, a processor, computer, server, or other devices as is known to one skilled in the art, for example, for both training and the classification of neural network or machine learning algorithms for pixel-by-pixel classifications.

The confidence value can be used here to exclude associated LiDAR points with pixels classified as unreliable according to a threshold value or their projection from use in the further procedure.

Furthermore, the confidence value in the method for instance segmentation of the LiDAR point cloud can be used to ensure the correctness of the class assignment of the detected instances.

Furthermore, the calculation device can be configured to project the pixel-based classified camera image data onto the pre-acquired LiDAR point cloud data, wherein the calculation device is configured to assign an identical class to points of the LiDAR point cloud, which are superimposed by classified pixels of the camera image data, in particular having the same image coordinates. The projection of the camera image data onto the pre-acquired LiDAR point cloud data is carried out by coordinate transformation.

Furthermore, the calculation device can be configured to perform an instance segmentation of the classified LiDAR point cloud data for determining at least one real object comprised by a class and means for selecting and calling a stored, synthetically generated first object or procedural generation of a synthetically generated second object corresponding to the at least one real object.

In addition, the calculation device can be configured to integrate the synthetically generated first or second object into a specified virtual vehicle environment.

The invention further relates to a computer program having program code to perform the method according to the invention when the computer program is executed on a computer.

The invention also relates to a computer-readable data carrier with program code of a computer program to perform the method according to the invention when the computer program is executed on a computer.

Machine learning algorithms are based on the use of statistical techniques to train a data processing device in such a way that it can perform a specific task without it having been explicitly programmed to do so. The goal of machine learning is to construct algorithms that can learn from data and make predictions. These algorithms create mathematical models that can be used, for example, to classify data.

Such machine learning algorithms are used, for example, when physical models, i.e., models based on physical conditions and/or dependencies, reach their limits, for example due to increased resource consumption.

The confidence value corresponding to the classification gives probabilities for each pixel of belonging to a specific class, usually selecting the class that has the highest probability. Furthermore, for example, a threshold value can be defined, which must at least be reached so that a valid classification result is available.

The transformation of a 3D point cloud detected by a LiDAR sensor into a 2D image is known, for example, from arXiv:2007.05490v1 9 Jul. 2020 “Camera-Lidar Integration: Probabilistic sensor fusion for semantic mapping”.

Instance segmentation describes the assignment of each class to separate instances. For example, if there are multiple vehicles in an image, each individual vehicle is classified as one instance, whereas semantic segmentation classifies all vehicles as one instance.

In the instance segmentation of the classified LiDAR point cloud data for determining real objects comprised by a class, objects of one class, for example individual vehicles of the class vehicle, can be identified or segmented into an instance. Each vehicle thus forms one instance of the vehicle class.

An object of the present invention is to automatically build a synthetic 3D scene from real video image data of a measurement drive of a motor vehicle.

As part of semantic segmentation or pixel-based classification, each point of the camera image data may be assigned a corresponding class. Subsequently, the acquired LiDAR point cloud data is refined by superimposing the classified camera image data. This is achieved by projecting the semantic segmentation or pixel-based classification of the camera image data onto the LiDAR point cloud data.

On the basis of the improved, reduced and thus more meaningful point cloud data, the instance segmentation is then carried out. Thus, the object or objects comprised by the class can be segmented or differentiated.

The instance segregation of the point cloud thus offers an advantage over using only camera image data in that the spatial component can be included for instance differentiation.

Based on class and instance, a suitable asset or synthetically generated object can then be searched for in a database. If there is a corresponding asset or an asset that has a certain degree of similarity, that asset is selected.

If a corresponding asset does not exist, it can be generated procedurally by specifying the corresponding class and instance.

By automating the scene building of the virtual vehicle environment using the data obtained from the real vehicle environment, a significant simplification of the scene building of the virtual vehicle environment, in conjunction with a considerable gain in efficiency and an associated reduction in cost, can thus be achieved in an advantageous manner.

The pixel-based classification of the pre-acquired camera image data is carried out by an algorithm of supervised learning or by an algorithm of unsupervised learning, in particular an artificial neural network. Thus, an algorithm can be used in an advantageous manner, which has optimal properties for the object according to the invention in terms of training effort or consumption of computing resources.

For a specified first number of classes, the selection and call of the stored synthetically generated first object corresponding to the at least one real object can be carried out, and for a specified second number of classes, in particular the procedural generation of the synthetically generated second object corresponding to the at least one real object is carried out.

Due to their variability, buildings are always generated procedurally, whereas traffic signs, for example, are stored in a data memory due to their limited number and can be selected accordingly.

Based on the instance segmentation of the classified LiDAR point cloud data for determining at least one real object included by a class, an extraction of features describing the at least one real object, in particular a size and/or a radius of the object, can be carried out. Thus, the information of the extracted features can be used advantageously by a downstream process.

Based on the extracted features, the procedural generation of the synthetically generated second object corresponding to the at least one real object can be carried out. By procedurally generating the synthetic object, a synthetic object corresponding to the real object can thus be generated.

Based on the extracted features, a comparison of the segmented, at least one real object of a class having a plurality of stored synthetically generated objects can be carried out. Thus, an efficient identification of a synthetically generated object associated with the real object can be carried out in an advantageous manner.

Comparisons can thus advantageously make it possible for an automatic assignment of corresponding real and synthetically generated objects to take place, so that the synthetically generated objects thus identified can then be integrated into the virtual vehicle environment.

Based on the comparison of the segmented, at least one real object of a class with a plurality of stored, synthetically generated objects, a stored synthetically generated first object having a predetermined similarity measure can be selected and called.

Thus, it can be advantageously enabled that a synthetic object having a high degree of similarity to the selected real object is callable.

The classes determined by an algorithm machine learning can represent, for example, buildings, vehicles, traffic signs, traffic lights, roadways, road markings, plantings, pedestrians and/or other objects. Thus, the objects conventionally contained in a scene can be reliably classified in an advantageous manner.

Further, respective points of the LiDAR point cloud, which are not superimposed by classified pixels of the camera image data, in particular can have the same image coordinates, are removed from the LiDAR point cloud. Thus, a reliability of detected objects of the scene can be improved in an advantageous manner.

The advantage of combining camera image data and LiDAR point cloud data results from the merging of information from different domains such as class, color values, etc., from camera image data as well as spatial information from LiDAR point cloud data.

Especially with building fronts and vegetation, it is not trivial to assign an instance only on the basis of camera data. For example, there is always the risk that two partially overlapping objects in the camera image, e.g., trees, are recognized as a single instance in the camera image, whereas segmentation in three-dimensional space allows for differentiation based on the Euclidean distance.

Furthermore, respective points of the LiDAR point cloud which are superimposed by classified pixels of the camera image data, which pixels have a confidence value that is less than a predetermined first threshold value, can be removed to provide reduced LiDAR point cloud data. This makes it possible for subsequent processing to be less susceptible to errors in the classification phase. This also increases the reliability of detected objects.

The instance segmentation of the classified LiDAR point cloud data for determining the at least one real object comprised by a class can be carried out using the reduced LiDAR point cloud data. The instance segmentation is thus performed using more reliable data, which in turn can improve the result of the instance segmentation.

The pre-acquired camera image data and LiDAR point cloud data can represent the same, simultaneously acquired real vehicle environment. Due to the calibration or orientation of the camera sensor and the LiDAR sensor to each other, a software-supported synchronization of the data can be dispensed with.

The features describing the at least one real object can be extracted by a further machine learning algorithm. Thus, an efficient feature extraction can be carried out in an advantageous manner.

The features of the method described herein are also applicable to other virtual environments such as the testing of other types of vehicles in different environments.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a flowchart of a computer-implemented method for generating a virtual vehicle environment for testing highly automated driving functions of a motor vehicle; and

FIG. 2 is a diagram of a system for generating a virtual vehicle environment for testing highly automated driving functions of a motor vehicle using pre-acquired video image data, radar data and/or a LiDAR point cloud of a real vehicle environment according to the preferred embodiment of the invention.

### DETAILED DESCRIPTION

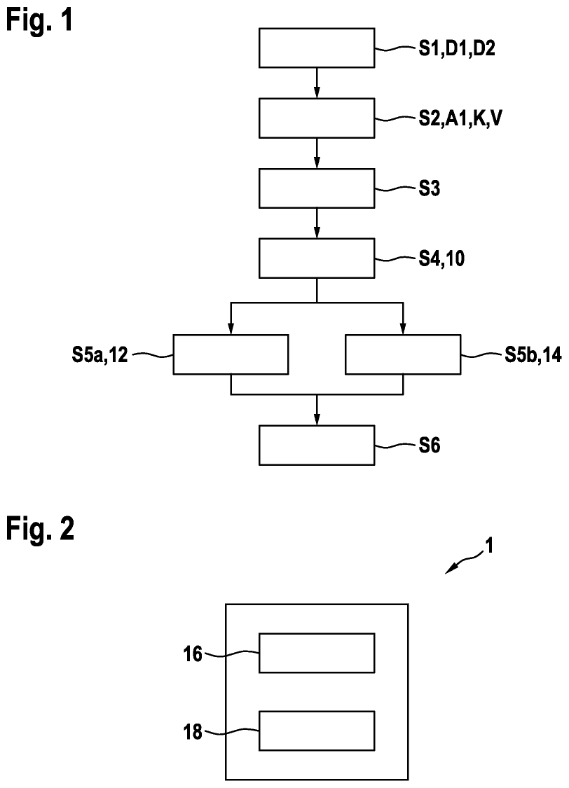

FIG. 1 shows a flowchart of a method for generating a virtual vehicle environment for testing highly automated driving functions of a motor vehicle.

The method comprises providing 51 pre-acquired camera image data D1 and LiDAR point cloud data D2 of a real vehicle environment and pixel-based classification S2 of the pre-acquired camera image data D1 using a machine learning algorithm A, which outputs an associated class K and a confidence value V corresponding to the classification.

The method further comprises a projection S3 of the pixel-based classified camera image data D1 onto the pre-captured LiDAR point cloud data D2, wherein respective points of the LiDAR point cloud superimposed by classified pixels of the camera image data D1, in particular having the same image coordinates, are assigned an identical class K.

Furthermore, the method comprises an instance segmentation S4 of the classified LiDAR point cloud data D2 for determining at least one real object 10 comprised by a class K and a selection and call S5a of a stored, synthetically generated first object 12 corresponding to the at least one real object 10 or procedural generation S5b of a synthetically generated second object 14 corresponding to the at least one real object 10.

In addition, the method comprises integrating S6 the synthetically generated first object 12 or the synthetically generated second object 14 into a specified virtual vehicle environment.

For a specified first number of classes K, the selection and call S5a of the stored, synthetically generated first object 12 corresponding to the at least one real object 10 is carried out. Furthermore, for a specified second number of classes K, in particular the procedural generation S4b of the synthetically generated second object 14 corresponding to the at least one real object 10 is carried out.

Based on the instance segmentation S4 of the classified LiDAR point cloud data D2 for determining at least one real object 10 comprised by a class K, an extraction of the features describing the at least one real object 10, in particular a size and/or a radius of the object, is carried out. Furthermore, based on the extracted features, the procedural generation S5b of the synthetically generated second object 14 corresponding to the at least one real object 10 is carried out.

Based on the extracted features, the segmented, at least one real object 10 of a class K is compared with a plurality of stored, synthetically generated objects.

In addition, based on the comparison of the segmented, at least one real object 10 of a class K with a plurality of stored, synthetically generated objects, a stored, synthetically generated first object having a specified similarity measure is selected and called.

The classes K determined by the machine learning algorithm A represent buildings, vehicles, traffic signs, traffic lights, roadways, road markings, plantings, pedestrians and/or other objects. Respective points of the LiDAR point cloud which are not superimposed by classified pixels of the camera image data D1, in particular having the same image coordinates, are removed from the LiDAR point cloud.

Respective points of the LiDAR point cloud, which are superimposed by classified pixels of the camera image data D1, which pixels have a confidence value V that is less than a specified first threshold value, are also removed to provide reduced LiDAR point cloud data D2.

The instance segmentation S4 of the classified LiDAR point cloud data D2 for determining the at least one real object 10 comprised by a class K is further performed using the reduced LiDAR point cloud data D2. The pre-acquired camera image data D1 and LiDAR point cloud data D2 represent the same real vehicle environment captured at the same time.

The features describing the at least one real object 10 are extracted by another machine learning algorithm.

FIG. 2 shows a diagram of a system 1 for generating a virtual vehicle environment for testing highly automated driving functions of a motor vehicle according to the preferred embodiment of the invention.

The system 1 comprises a data memory 16 for providing pre-acquired camera image data D1 and LiDAR point cloud data D2 of a real vehicle environment and a calculation device 18, which is configured to perform a pixel-based classification of the pre-acquired camera image data D1 using a machine learning algorithm A designed to output for each pixel an associated class K and a confidence value V corresponding to the classification.

The calculation device 18 is further configured to perform a projection of the pixel-based classified camera image data D1 onto the pre-acquired LiDAR point cloud data D2, wherein the calculation device 18 is configured to assign an identical class K to respective points of the LiDAR point cloud superimposed by classified pixels of the camera image data D1, in particular having the same image coordinates.

Furthermore, the calculation device 18 is configured to perform an instance segmentation of the classified LiDAR point cloud data D2 for determining at least one real object 10 comprised by a class K. The calculation device 18 is also configured to select and call a stored, synthetically generated first object 12 or perform a procedural generation of a synthetically generated second object 14 corresponding to the at least one real object 10.

Furthermore, the calculation device 18 is configured to integrate the synthetically generated first or second object 14 into a specified virtual vehicle environment.

Although specific embodiments have been illustrated and described herein, it is understood to the person skilled in the art that a variety of alternative and/or equivalent implementations exist. It should be noted that the exemplary embodiment or exemplary embodiments are examples only and are not intended to limit the scope, applicability or configuration in any way.

Rather, the above-mentioned summary and detailed description provides the skilled person with a convenient guide for implementing at least one exemplary embodiment, it being understood that various changes in the functionality and arrangement of the elements can be made without departing from the scope of the attached claims and their legal equivalents.

In general, this application is intended to cover changes or adaptations or variations of the embodiments presented herein. For example, a sequence of method steps can be modified. The method can also be carried out, at least in sections, sequentially or in parallel.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for creating a virtual vehicle environment for testing highly automated driving functions of a motor vehicle, the method comprising:
providing pre-acquired camera image data and LiDAR point cloud data of a real vehicle environment;
performing pixel-based classification of the pre-acquired camera image data using a machine learning algorithm, which outputs an associated class and a confidence value corresponding to the classification for each pixel;
projecting the pixel-based classified camera image data onto the pre-acquired LiDAR point cloud data, wherein each point of the LiDAR point cloud, superimposed by classified pixels of the camera image data or points having the same image coordinates, is assigned an identical class;
instance segmenting the classified LiDAR point cloud data to determine at least one real object comprised by a class;
selecting and calling a stored, synthetically generated first object corresponding to the at least one real object or procedural generation of a synthetically generated second object corresponding to the at least one real object; and
integrating the synthetically generated first object or the synthetically generated second object into a specified virtual vehicle environment.

2. The computer-implemented method according to claim 1, wherein for a specified first number of classes the selection and call of the stored, synthetically generated first object corresponding to the at least one real object is carried out and for a specified second number of classes, in particular the procedural generation of the synthetically generated second object corresponding to the at least one real object, is carried out.

3. The computer-implemented method according to claim 1, wherein, based on the instance segmentation of the classified LiDAR point cloud data for determining at least one real object comprised by a class, an extraction of features describing the at least one real object, in particular a size and/or a radius of the object, is performed.

4. The computer-implemented method according to claim 3, wherein based on the extracted features, the procedural generation of the synthetically generated second object corresponding to the at least one real object is carried out.

5. The computer-implemented method according to claim 3, wherein based on the extracted features, a comparison of the segmented, at least one real object of a class with a plurality of stored, synthetically generated objects is performed.

6. The computer-implemented method according to claim 5, wherein based on the comparison of the segmented, at least one real object of a class with a plurality of stored, synthetically generated objects, a stored, synthetically generated first object having a specified similarity measure is selected and called.

7. The computer-implemented method according to claim 1, wherein the classes determined by a machine learning algorithm represent buildings, vehicles, traffic signs, traffic lights, roadways, road markings, plantings, pedestrians and/or other objects.

8. The computer-implemented method according to claim 1, wherein respective points of the LiDAR point cloud, which are not superimposed by classified pixels of the camera image data, in particular having the same image coordinates, are removed from the LiDAR point cloud.

9. The computer-implemented method according to claim 1, wherein respective points of the LiDAR point cloud, which are superimposed by classified pixels of the camera image data, which pixels have a confidence value that is less than a predetermined first threshold, are removed in order to provide reduced LiDAR point cloud data.

10. The computer-implemented method according to claim 9, wherein the instance segmentation of the classified LiDAR point cloud data for determining the at least one real object comprised by a class is performed using the reduced LiDAR point cloud data.

11. The computer-implemented method according to claim 1, wherein the pre-acquired camera image data and LiDAR point cloud data represent the same real vehicle environment captured at the same time.

12. The computer-implemented method according to claim 3, wherein the features describing the at least one real object are extracted by a further machine learning algorithm.

13. A system to generate a virtual vehicle environment for testing highly automated driving functions of a motor vehicle using pre-acquired video image data, radar data and/or a LiDAR point cloud of a real vehicle environment, the system comprising:
a data memory to provide pre-acquired camera image data and LiDAR point cloud data of a real vehicle environment;
a calculation device for pixel-based classification of the pre-acquired camera image data using a machine learning algorithm which is configured to output for each pixel an associated class and a confidence value corresponding to the classification,
wherein the calculation device is configured to project the pixel-based classified camera image data onto the pre-acquired LiDAR point cloud data and to assign an identical class to respective points of the LiDAR point cloud, each superimposed by classified pixels of the camera image data, in particular having the same image coordinates,
wherein the calculation device is configured to perform an instance segmentation of the classified LiDAR point cloud data to determine at least one real object comprised by a class,
wherein the calculation device is configured to select and call a stored, synthetically generated first object or a procedural generation of a synthetically generated second object corresponding to the at least one real object, and
wherein the calculation device is configured to integrate the synthetically generated first or second object into a specified virtual vehicle environment.

14. A computer program with program code for performing the method according to claim 1 when the computer program is executed on a computer.

15. A computer-readable data carrier comprising program code of a computer program for performing the method according to claim 1 when the computer program is executed on a computer.
